(19) United States
(12) Patent Application Publication
(10) Pub. No.: US 2003/0083992 A1
(43) Pub. Date: May 1, 2003

(54) System and method for opening on-line transaction account

(75) Inventor: Chia-Chi Chang, Taipei (TW)

Correspondence Address: TROXELL LAW OFFICE PLLC, SUITE 1404, 5205 LEESBURG PIKE, FALLS CHURCH, VA, 22041, US

(73) Assignee: NetBuck Payment Service Co., Ltd.

(21) Appl. No.: 10/028,821

(22) Filed: Dec. 28, 2001

(30) Foreign Application Priority Data
Oct. 31, 2001 (TW) 90127037

(51) Int. Cl. G06F 17/60

(52) U.S. Cl. 705/42

(57) ABSTRACT

The present invention provides a data processing system for processing a request asserted by a person for opening an account. The person has a communication device, e.g., telephone, mobile phone, personal digital assistance and notebook, etc. The system includes a receiving module, an inquiring module and a processing module. The receiving module is for receiving a request information representing the request from the person and generating an inquiry information responsive to the request information. The request information includes a communication number associated with the communication device. The inquiring module is for receiving the inquiry information from the receiving module and the communication number, and according to the communication number, transmitting the inquiry information to the communication device to contact the person. The processing module is for receiving a response information responsive to the inquiry information through the inquiring module, and selectively opening the account in accordance with the response information.

### FIELD OF THE INVENTION

The present invention relates to a system and method for opening an account on the internet, e.g., an on-line account or a virtual account. More in particular, before opening an account, the system and method provided by the present invention will certify the identity of the person through his or her own communication device first, and then it will decide whether to open an account for the person or not.

### BACKGROUND OF THE INVENTION

By the blooming of the internet, more and more people are getting used to consuming on the internet, and the consuming mode on the internet is mostly paid by credit cards on-line now. As for the application of paying by credit cards on-line, please refer to the prior art—U.S. Pat. No. 6,135,349. However, according to the above mentioned mode, if a consumer wants to make a deal on the internet, s/he must have a credit card first. Yet, the process of the application for credit cards is fairly complex, and the requirement of many documents is a must. In consequence, it becomes very troublesome for those who want to consume by credit cards.

Therefore, an objective of the invention is to provide a system and method for opening an account used on the internet, for example, an on-line account or a virtual account. Namely, according to the system and method provided by the invention, an exclusive account could be quickly and easily opened for a person, and this account could be valid and operated on the internet. Therefore, the person could use the new opened account to make a deal on the internet and doesn't need to apply for any credit cards.

Besides, in the present internet consuming behavior, many web companies have started to request a small fee for service which is free originally. However, the request of a small fee for each transaction or service by using credit cards or other conventional financial tools gets involved in many problems. For instance, when customers use credit cards, the web companies have to afford the handling fees which are higher than income; moreover, web companies also need a king's ransom to establish conventional electronic business devices. In order to solve these problems, more and more web companies begin to issue stored-value cards. Yet, stored-value cards still need to be sold in the real world, and here come the problems: the marketing cost is too high; consumers must purchase different stored-value cards because cards are issued by different web companies; namely, they are not all-in-ones; the web companies must establish the recognizing apparatuses which cost a lot of money; and the charging systems can't afford small fees and high volume of trade, etc.

Therefore, another objective of the invention is to provide an on-line transaction account; and in particular, the account could not only provide web companies a low-price and highly-competitive total-solution plan for small charge, but also provide the Net users a safe and convenient transaction mode in which any real financial cards such as credit cards or stored-value cards are no longer in need.

In addition, there are some prior arts about the automation of Account Opening such as U.S. Pat. No. 6,182,131 and U.S. Pat. No. 6,292,904. However, there are not yet any techniques associated with how to confirm the identity of the account opener, in order to avoid the account being opened by a fake identity for the purpose of illegal conduct during the process of the automation of the account opening. If the identity could be certified during the process of the account opening, the financial fraud could be avoided. And, by comparison, this kind of on-line transaction account will make consumers fell more secure and like to make deals often. However, if the identify want to be certified in the process of the account opening, the cost of the extra special skills must be low—not too high to be practiced.

Therefore, another objective of the present invention is to utilize the communication technology such as the short massage sending technology to provide a low-cost system and method, and this system and method is able to confirm the identity of the person. As for the prior art of the short massage sending technology, please refer to U.S. Pat. No. 6,151,507.

As we know, most people nowadays own many financial tools (e.g., credit cards), accounts, stored-value cards, or charging accounts (e.g. mobile phone charging account) . . . etc., which have been stored money or can get cash in advance. If the web merchants do not have a convenient way to open a new account, they will fail to attract a consumer to open a new account and transfer his/her money from the other financial tools or accounts to this new account.

Therefore, another objective of the invention is to provide a system and method for the person who could easily transfer his/her money on the internet; in particular, after the account is opened, the present invention could make the person easily transfer his/her money from his/her other accounts to the new opened account. So, the public might have a motive to open a new account and use this new account by means of the system and method of the invention.

### SUMMARY OF THE INVENTION

An objective of the present invention is to provide a system and method for opening an account on the internet, e.g. an on-line account or a virtual account. The system and method according to the present invention could quickly and easily open an exclusive account for a person, and the account could be operated on the internet. Then, the person could use the opened account to consume on the internet and doesn't need to apply for any credit cards before dealing.

Another objective of the present invention is to provide an on-line transaction account. In particular, the account provides a total solution for requesting small fees which reduces the costs and raises the competitive ability for the web companies; furthermore, it also provides a safe but more convenient transaction mode for Net-users that do not need any real financial cards such as credit cards or stored-value cards.

Another objective of the present invention is to utilize the communication technology such as short massage sending technology for providing a low-cost system and method, and this system and method could affirm the identity of the person who requests to open an on-line account.

Another objective of the invention is to provide a system and method for the person to open an account applicable to the internet, and in particular, after the opening of the account, the person could easily transfer a predetermined amount of money from other accounts to this new opened account.

In a preferred embodiment, the invention provides a data processing system for processing a request asserted by a person for opening an account, and the person has a communication device, e.g., telephone, mobile phone, personal digital assistance and notebook, etc. The system includes a receiving module, an inquiring module and a processing module. The receiving module is for receiving a request information representing the request from the person and generating an inquiry information responsive to the request information including a communication number associated with the communication device. The inquiring module is for receiving the inquiry information from the receiving module and the communication number, and according to the communication number, transmitting the inquiry information to the communication device to contact the person. The processing module is used for receiving a response information responsive to the inquiry information through the inquiring module, and selectively opening the account in accordance with the response information.

The strengths and spirits of the present invention could be more understandable by the following detailed description of the preferred embodiments and the attached figures and drawings.

### BRIEF DESCRIPTION OF THE APPENDED DRAWINGS

FIG. 1 is a schematic diagram of practicing environment according to the first preferred embodiment of the invention.

FIG. 2 is an information processing flow chart according to the first preferred embodiment of the invention.

FIG. 3 is a schematic diagram of practicing environment according to the second preferred embodiment of the invention.

FIG. 4 is an information processing flow chart according to the second preferred embodiment of the invention.

### DETAILED DESCRIPTION OF THE INVENTION

The invention relates to a system and method for opening an account that is used on the internet, e.g., an on-line account or a virtual account. According to the system and method of this present invention, a person who likes to open an account could easily open her/his own account applicable to the internet, by using her/his communication devices; afterwards, s/he could consume on the internet by using the opened account without any real cards such as credit cards or stored-value cards. Namely, by applying the invention, account openers could easily get rid of the inconvenience and the disadvantage of the real cards. And the system and method provided by the present invention also enables web companies not to buy a great deal of additional data processing devices. Accordingly, web companies not only save a lot of marketing cost spent on the real cards before, but also improve the efficiency of the service. In the following, several preferred embodiments of the invention would be described in detail to fully express the characteristics, spirits, strengths, and feasibility of the application of this present invention.

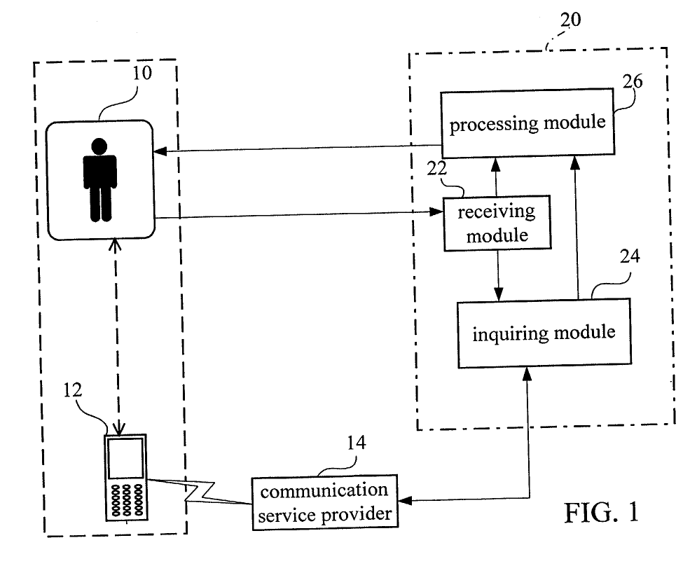

Referring to FIG. 1, it is one of the schematic diagrams of the practicing environment of the data processing system 20, according to the first preferred embodiment of the invention. In the first preferred embodiment, the invention provides the data processing system 20 for processing a request asserted by the person 10 for an account opening. It is noted that the account is not opened yet, so that it is not shown in the FIG. 1. The person 10 has a communication device 12, such as telephone, mobile phone, personal digital assistance or notebook, and so on, which is connected to the data processing system 20 through a communication service provider 14.

The information processing system 20, according to first preferred embodiment of the invention, includes a receiving module 22, an inquiring module 24, and a processing module 26. The receiving module 22 is for receiving a request information, representing the request from the person 10. The request information includes a communication number which is associated with the communication device 12. It is noted that when the receiving module 22 receives a request information, the system 20 is not certain whether the request information is declared by the person 10 or not. Meanwhile, the receiving module 22 also generates an inquiry information. The inquiry information is responded to the request information.

As for the inquiring module 24, it is used for receiving the inquiry information and the communication number from the receiving module 22, and according to the communication number, transmitting the inquiry information via the communication service provider 14 to the communication device 12 to contact the person 10. As to the processing module 26, it is used for receiving a response information responsive to the inquiry information through the inquiring module 24, and selectively opening the account in accordance with the response information. Namely, if the response information indicates that the identity of the person 10 is affirmed, the processing module 26 would open the account for the person 10. And if the response information can't affirm the identity of the person 10, or if the response information indicates that the owner of the communication device 12 is not the person 10, the processing module 26 would not execute the step of the account opening for the person 10 in order to avoid that the person 10 pretends others' identities to request the opening of the account.

In one embodiment, the response information includes a first password defined by the person 10, and when the processing module 26 opens the account, the processing module 26 will also define a second password for accessing the account, as being equal to the first password. In one embodiment, the inquiry information is transmitted in a form of short message.

In one embodiment, the account is an on-line transaction account. In another embodiment, the data processing system 20 is linked to a network, and the account is a virtual account used over the network. In one embodiment, when the processing module 26 opens the account, the processing module 26 will also define an account number associated with the account as being equal to the communication number.

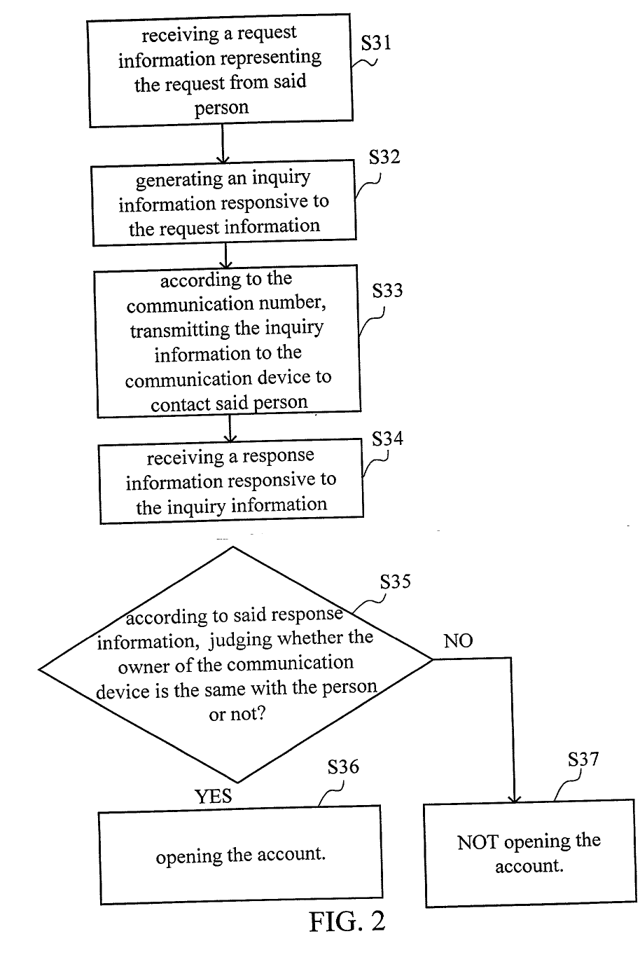

What follows will describe the information processing procedure of the information processing system 20 in detail, according to the first preferred embodiment of the invention. Referring to FIG. 2, first, execute step S31: the information processing system 20 receives a request information representing the request from the person 10. The request information includes a communication number associated with the communication device 12. It is noted that when the receiving module 22 receives a request information, the system 20 is not affirmed whether the request information is declared by the person 10 or not. Then, go to step S32: the information processing system 20 generates an inquiry information responsive to the request information. Afterward, go to step S33: according to the communication number, the information processing system 20 transmits the inquiry information to the communication device 12 to contact the person 10. Then, go to step S34: the information processing system 20 receives a response information responsive to the inquiry information.

Next, go to step S35: according to the response information, the information processing system 20 judges whether the owner of the communication device 12 is the same as the person 10 or not, or affirms the identity of the person. Then, if the result is “YES” in step S35, go to step S36: the information processing system 20 executes the step of opening the account. And, if “NO” in step S35, go to step S37: the information processing system 20 doesn't execute the step of opening the account.

For a consumer to conveniently and safely open an on-line account by means of the invention, and also for the consumer to easily transmit a predetermined amount of money from an existing account to this new opened account and to then consume on the internet by using the new opened account, the second preferred embodiment of this present invention will be described in detail as follows, to show how the invention achieves the efficiency and objectives of above mentioned.

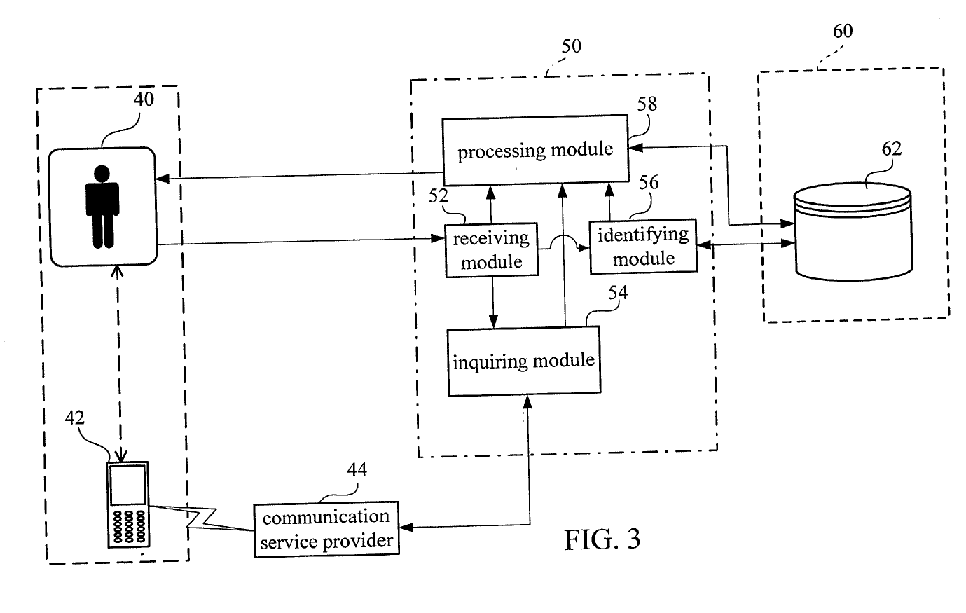

Referring to FIG. 3, it is a schematic diagram of practicing environment of a data processing system 50 according to the second preferred embodiment of the invention. The data processing system 50 is for identifying and processing a request asserted by a person 40 for opening a first account and transferring a predetermined amount of money from a second account 62 into the first account. The second account 62 being held by the person 40. It is noted that the first account is not opened yet, so that it isn't shown in the FIG. 3. Besides, the person 40 has a communication device 42.

The system 50 includes a receiving module 52, an inquiring module 54, an identifying module 56, and a processing module 58. The receiving module 52 is utilized for receiving a request information representing the request from the person 40. The request information includes a communication number associated with the person 40 and an identification information associated with the second account 62. It is noted that when the receiving module 52 receives the request information, it is not certain that the request is declared by the 40. Meanwhile, the receiving module 52 also generates an inquiry information responsive to the request information. As for the inquiring module 54, it is utilized for receiving the inquiry information from the receiving module 52 and the communication number, and according to the communication number, transmitting the inquiry information to contact the person 40 to identify whether the request is asserted by the person 40 or not. As to the identifying module 56, it is utilized for receiving the identification information associated with the second account 62 from the receiving module 52, and according to the identification information associated with the second account 62, identifying whether the second account is valid or not. When the inquiring module identifies that the request is asserted by the person 40, and when the identifying module identifies that the account is valid, the processing module 58 will be utilized for opening the first account, and then transferring the predetermined amount of money from the valid second account 62 into the first opened account.

In one embodiment, when the processing module 58 opens the first account, the processing module 58 also defines an account number associated with the first account as being equal to the communication number.

In one embodiment, the response information includes a first password defined by the person 40, and when the processing module 58 opens the first account, the processing module 58 also defines a second password, for accessing the first account, as being equal to the first password.

In one embodiment, the inquiry information is transmitted in a form of short message.

In one embodiment, the account is an on-line transaction account. In another embodiment, the data processing system 50 is linked to a network, and the account is a virtual account used over the network.

In one embodiment, the second account 62 is a stored-value card account or a financial account.

In one embodiment, the second account 62 is not issued by the account issued institution 60 as shown in FIG. 3, but the second account 62 which is an charge account associated with the communication device 42.

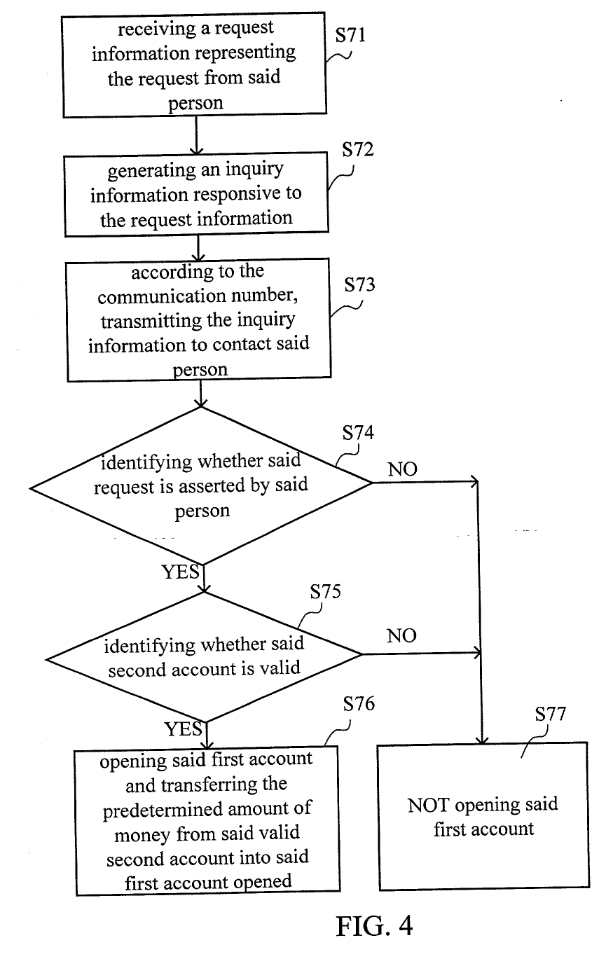

What follows is a detailed description of the information processing procedure of the information processing system 50 according to the second preferred embodiment of the invention. Referring to FIG. 4, the first step is to execute step S71: the information processing system 50 receives a request information representing the request from the person. And, the request information includes a communication number associated with the person 40 and an identification information associated with the second account 62. It is noted that when the system 50 receives a request information, the system 50 is not affirmed whether the request information is declared by the person 10 or not. Then, go to step S72: the information processing system 50 generates an inquiry information responsive to the request information. Next, go to step S73: the information processing system 50, according to the communication number, transmits the inquiry information to contact the person 40 to identify whether the request is asserted by the person 40 or not. And, if the result of step S73 is “NOT”, go to step S77: the information processing system 50 doesn't execute the step of opening the first account. But if the result of step S37 is “YES”, go to step S74.

In step S74, according to the identification information associated with the second account 62, the information processing system 50 identifies whether the second account 62 is valid or not. If the result of step S74 is “NOT”, go to step S77: the information processing system 50 doesn't execute the step of opening the first account. Yet, if the result of step S74 is “YES”, go to step S75: the information processing system 50 opens the first account when the system 50 identifies that the request is asserted by the person 40, and when the system 50 identifies that the second account 62 is valid; then, transferring the predetermined amount of money from the valid second account 62 into the first account opened.

To sum up, the description of the above mentioned preferred embodiments is for providing a better understanding on the strengths and spirits of this present invention, not for limiting the domain of the invention. Moreover, it aims to include various modification and arrangement parallel in form into the domain of the patent applied by this present invention. Due to the above mentioned, the domain of the patent applied by the invention should be explained in a macro view to cover all kinds of possible modification and arrangement of equal form.

What is claimed is:

1. A data processing system for processing a request asserted by a person for opening an account, said person having a communication device, said system comprising:
a receiving module for
receiving a request information representing the request from said person, the request information comprising a communication number associated with the communication device, and
generating an inquiry information responsive to the request information;
an inquiring module for
receiving the inquiry information from said receiving module and the communication number, and
according to the communication number, transmitting the inquiry information to the communication device to contact said person; and
a processing module for
receiving a response information responsive to the inquiry information through said inquiring module, and
selectively opening said account in accordance with said response information.

2. The data processing system of claim 1, wherein when said processing module opens said account, said processing module also defines an account number associated with said account as being equal to the communication number.

3. The data processing system of claim 2, wherein said response information comprises a first password defined by said person, and when said processing module opens said account, said processing module also defines a second password, for accessing said account, as being equal to the first password.

4. The data processing system of claim 3, wherein the inquiry information is transmitted in a form of short message.

5. The data processing system of claim 4, wherein said account is an on-line transaction account.

6. The data processing system of claim 4, also linking to a network, wherein said account is a virtual account used over the network.

7. A data processing system for identifying and processing a request asserted by a person for opening a first account and transferring a predetermined amount of money from a second account into said first account, said second account being held by said person, said system comprising:
a receiving module for
receiving a request information representing the request from said person, the request information comprising a communication number associated with said person and an identification information associated with said second account, and
generating an inquiry information responsive to the request information;
an inquiring module for
receiving the inquiry information from said receiving module and the communication number, and
according to the communication number, transmitting the inquiry information to contact said person to identify whether said request is asserted by said person; and
an identifying module for
receiving the identification information associated with said second account, and
according to the identification information associated with said second account, identifying whether said second account is valid;
a processing module for
when said inquiring module identifies that said request is asserted by said person, and when said identifying module identifies that said account is valid, opening said first account, and
transferring the predetermined amount of money from said valid second account into said first account opened.

8. The data processing system of claim 7, wherein when said processing module opens said first account, said processing module also defines an account number associated with said first account as being equal to the communication number.

9. The data processing system of claim 8, wherein said inquiring module also receives a response information responsive to the inquiry information from said person, the response information comprises a first password defined by said person, and when said processing module opens said first account, said processing module also defines a second password, for accessing said first account, as being equal to the first password.

10. The data processing system of claim 9, wherein the inquiry information is transmitted in a form of short message.

11. The data processing system of claim 10, wherein said first account is an on-line transaction account.

12. The data processing system of claim 10, also linking to a network, wherein said first account is a virtual account used over the network.

13. The data processing system of claim 10, wherein said second account is a stored-value card account.

14. The data processing system of claim 10, wherein said second account is a financial account.

15. The data processing system of claim 10, wherein the communication number is associated with a communication device of said person, and said second account is an account associated with the communication device.

16. A data processing method for processing a request asserted by a person for opening an account, said person having a communication device, said method comprising the steps of:
(a) receiving a request information representing the request from said person, the request information comprising a communication number associated with the communication device;
(b) generating an inquiry information responsive to the request information;
(c) according to the communication number, transmitting the inquiry information to the communication device to contact said person;
(d) receiving a response information responsive to the inquiry information;
(e) selectively opening said account in accordance with said response information.

17. The data processing method of claim 16, wherein when said account is opened, an account number associated with said account is defined as being equal to the communication number.

18. The data processing method of claim 17, wherein said response information comprises a first password defined by said person, and when said account is opened, a second password for accessing said account is defined as being equal to the first password.

19. The data processing method of claim 18, wherein the inquiry information is transmitted in a form of short message.

20. The data processing method of claim 19, wherein said account is an on-line transaction account.

21. The data processing method of claim 19, being also employed in a network, wherein said account is a virtual account used over the network.

22. A data processing method for identifying and processing a request asserted by a person for opening a first account and transferring a predetermined amount of money from a second account into said first account, said second account being held by said person, said method comprising the steps of:
(a) receiving a request information representing the request from said person, the request information comprising a communication number associated with said person and an identification information associated with said second account;
(b) generating an inquiry information responsive to the request information;
(c) according to the communication number, transmitting the inquiry information to contact said person to identify whether said request is asserted by said person;
(d) according to the identification information associated with said second account, identifying whether said second account is valid;
(e) opening said first account when said inquiring module identifies that said request is asserted by said person, and when said identifying module identifies that said second account is valid; and
(f) transferring the predetermined amount of money from said valid second account into said first account opened.

23. The data processing method of claim 22, wherein when said first account is opened, an account number associated with said first account is defined as being equal to the communication number.

24. The data processing method of claim 23, wherein the step (c) also receiving a response information responsive to the inquiry information from said person, the response information comprises a first password defined by said person, and when said first account is opened, a second password for accessing said first account is defined as being equal to the first password.

25. The data processing method of claim 24, wherein the inquiry information is transmitted in a form of short message.

26. The data processing method of claim 24, wherein said first account is an on-line transaction account.

27. The data processing method of claim 24, also linking to a network, wherein said first account is a virtual account used over the network.

28. The data processing method of claim 24, wherein said second account is a stored-value card account.

29. The data processing method of claim 24, wherein said second account is a financial account.

30. The data processing method of claim 24, wherein the communication number is associated with a communication device of said person, and said second account is an account associated with the communication device.
